(19) United States
(12) Patent Application Publication
(10) Pub. No.: US 2025/0285002 A1
(43) Pub. Date: Sep. 11, 2025

(54) QUANTUM COMPUTING DEVICE FOR HYBRID ERROR MITIGATION BY RESTRICTED EVOLUTION AND METHOD THEREOF

(71) Applicant: LG ELECTRONICS INC., Seoul (KR)

(72) Inventors: Gaurav SAXENA, Toronto (CA); Thi Ha KYAW, Burlington (CA)

(73) Assignee: LG ELECTRONICS INC., Seoul (KR)

(21) Appl. No.: 18/929,092

(22) Filed: Oct. 28, 2024

Related U.S. Application Data
(60) Provisional application No. 63/563,925, filed on Mar. 11, 2024.

(51) Int. Cl. G06N 10/70; G06N 10/20

(52) U.S. Cl. CPC G06N 10/70; G06N 10/20

(57) ABSTRACT

A method for mitigating error in a quantum computing device can include receiving a quantum circuit configuration including a plurality of quantum gates, and generating an updated quantum circuit configuration by replacing a first gate among the plurality of quantum gates with at least one implemental quantum gate selected from among a set of implementable quantum gates based on a generalized quasi-probabilistic decomposition including a positive component and replacing a second gate among the plurality of quantum gates with at least two implemental quantum gates selected from among the set of implementable quantum gates based on a full quasi-probabilistic decomposition including a positive component and a negative component. Also, the method can further include executing the updated quantum circuit configuration, by the quantum computing device, to generate an expectation value.

### CROSS-REFERENCE TO RELATED APPLICATIONS

This non-provisional application claims priority under 35 U.S.C. § 119(e) to U.S. Provisional Application No. 63/563,925, filed on Mar. 11, 2024, the entirety of which is hereby expressly incorporated by reference into the present application.

### BACKGROUND

### Field

The present disclosure relates to a device and method for error mitigation in a quantum computer. Particularly, the method can perform hybrid error mitigation by restricted evolution (HEMRE), in the field of quantum computing and artificial intelligence (AI). Further, the method can perform hybrid error mitigation by restricted evolution (HEMRE) and provide an adjustable runtime according to bias tolerance.

### Discussion of the Related Art

Quantum computers represent a revolutionary leap forward in computing technology with their potential to solve complex problems exponentially faster than classical computers.

Unlike classical computers that use transistors to implement binary bits, which can be either 0 or 1, quantum computers use qubits. Qubits can exist in a superposition of states, allowing them to perform multiple calculations simultaneously and potentially tackle problems that are intractable by classical computers.

For example, quantum computers promise a quantum advantage in numerous applications, such as factoring, solving linear systems, quantum simulations, and quantum chemistry/material discovery.

However, the power of quantum computers comes with unique challenges, such as dealing with noise and decoherence. Quantum systems are inherently fragile and susceptible to various sources of noise and errors. These errors can arise from interactions with the environment, imperfections in hardware components, or limitations in control and measurement mechanisms.

For example, hybrid quantum computers that implement an architecture of a classical computer and a quantum computer working together to solve a problem, also referred to as noisy intermediate scale quantum (NISQ) computers, can execute algorithms that are often designed for short-depth quantum circuits having limited numbers of qubits and gates, e.g., variational quantum algorithms (VQAs) and in the form of a hybrid quantum-classical feedback loop.

However, even NISQ computers having short-depth quantum circuits are not fault tolerant, and the presence of noise and errors can limit their utility. For example, the result output by a quantum computer may be so influenced by noise and errors that its output becomes unreliable or unusable.

In order to extend the reach of near-term quantum computers and NISQ computers, error mitigation techniques are used, such as deploying a mixture of quantum sampling and post-processing techniques.

However, the existing error mitigation techniques require either exponential copies of quantum states or an exponential number of sampling measurements, with respect to the amount of noise present in the quantum hardware. Thus, such techniques become impractical with an increase in the system size and have exponential runtime (e.g., O(2ⁿ)).

For example, zero-noise extrapolation (ZNE) and probabilistic error cancellation (PEC) are two types of algorithms that can be used for dealing with errors in quantum computers. While PEC can give an unbiased estimate of the expectation value, it does so at the cost of an exponential sampling overhead (e.g., exponential runtime). On the other hand, ZNE gives a biased estimate by applying the quantum circuit several times and extrapolating the results of each run, in order to get a result which is often inaccurate and is computationally expensive.

Thus, there exists a need for being able to mitigate error in a quantum computer while having reduced sampling overhead and a shorter runtime while still providing an accurate estimate of the expectation value. More particularly, a need exists for determining a reliable estimate of the expectation value with a quantum computer in constant runtime (e.g., O(1)).

Further, a need exists for a more elegant error mitigation technique that can reduce processing time and conserve resources while still providing accurate and reliable results. Also, a need exists for an improved error mitigation method that provide a flexible hybrid approach in balancing error mitigation and bias with computational overhead, which can cater to practical application requirements of near-term and early-fault tolerant quantum devices.

Also, a need exists for error mitigation technique that can adequately mitigate error while providing an adjustable runtime according to bias tolerance.

### SUMMARY OF THE DISCLOSURE

The present disclosure has been made in view of the above problems and it is an object of the present disclosure to provide a device and method that can mitigate errors in a quantum computer. Further, the method can perform error mitigation by hybrid restricted evolution (HEMRE), in the field of quantum computing and artificial intelligence (AI). Also, the method can mitigate the exponential computational overhead associated with quantum error mitigation while preserving reasonable accuracy and providing an adjustable runtime according to bias tolerance.

An object of the present disclosure is to provide a method for mitigating error in a quantum computing device that includes receiving a quantum circuit configuration including a plurality of quantum gates, generating an updated quantum circuit configuration by replacing a first gate among the plurality of quantum gates with at least one implemental quantum gate selected from among a set of implementable quantum gates based on a generalized quasi-probabilistic decomposition including a positive component and replacing a second gate among the plurality of quantum gates with at least two implemental quantum gates selected from among the set of implementable quantum gates based on a full quasi-probabilistic decomposition including a positive component and a negative component, and executing the updated quantum circuit configuration, by the quantum computing device, to generate an expectation value.

It is another object of the present disclosure to provide a method that includes repeatedly executing, by the quantum computing device, the updated quantum circuit configuration for a predetermined number of runs to generate a plurality of expectations values, storing the plurality of expectations values corresponding to the predetermined number of runs in a memory of the quantum computing device, and outputting an average expectation value corresponding to an average of the plurality of expectations values.

Another object of the present disclosure is to provide a method that includes receiving a maximum tolerable bias for the expectation value, determining a first group of gates within the quantum circuit configuration to be approximated based on corresponding generalized quasi-probabilistic decompositions based on the maximum tolerable bias, and determining a second group of gates within the quantum circuit configuration to be represented based on corresponding full quasi-probabilistic decompositions.

An object of the present disclosure is to provide a method that includes obtaining an index including the plurality of quantum gates sorted from a smallest generalized robustness to a greatest generalized robustness, selecting a selected gate from the index and comparing the selected gate to a first condition, and in response to the first condition being satisfied, adding the selected gate to the first group of gates to be approximated.

Another object of the present disclosure is to provide a method in which the first condition is defined by Equation: s_{incl}*(gr[G])^{fr[G]}≤Δ_{fixed}−ϵ+1, in which s_{incl} is a product of generalized robustness corresponding to the first group before the selected gate is added to the first group, gr[G] is a generalized robustness of the selected gate, fr[G] is a number of instances of the selected gate within the quantum circuit configuration, Δ_{fixed} is the maximum tolerable bias, and ϵ is a predetermined value corresponding to a precision of a sampling operation used while executing the updated quantum circuit configuration.

An object of the present disclosure is to provide a method that includes repeatedly iterating through the index and adding gates from among the plurality of gates to the first group until the first condition is violated, and in response to the first condition being violated, adding one or more remaining gates among the plurality of gates to the second group.

Yet another object of the present disclosure is to provide a method that includes obtaining an index including the plurality of quantum gates sorted from a greatest generalized robustness to a smallest generalized robustness, determining a first range of gates within the index to be approximated based on a first condition associated with a first generalized robustness of the first range of gates, determining a first sampling overhead associated with generating the expectation value based on approximating gates included in the first range of gates, determining a second range of gates within the index to be approximated based on a second condition associated with a second generalized robustness of the second range of gates, determining a second sampling overhead associated with generating the expectation value based on approximating gates included in the second range of gates, comparing the second sampling overhead with the first sampling overhead, and in response to the second sampling overhead being less than first sampling overhead, proceed to determining a third range of gates within the index to be approximated or outputting the second range of gates as the first group of gates within the quantum circuit configuration to be approximated.

An object of the present disclosure is to provide a method in which the full quasi-probabilistic decomposition is based on equation U=sB−(s−1)N, where U corresponds to a quantum gate in the quantum circuit configuration, B is a probabilistic combination of implementable quantum gates, N is a quantum channel, and s is a coefficient corresponding to a generalized robustness, sB corresponds to a positive component and −(s−1)N corresponds to a negative component, and the generalized quasi-probabilistic decomposition is based on sB and is not based on −(s−1)N.

Another object of the present disclosure is to provide a method in which B is a probabilistic sum of at least two implementable operations including pₐA+p_{b}B, where A is a first implementable gate, B is a second implementable gate, pₐ is a first probability, and p_{b} is a second probability.

An object of the present disclosure is to provide a method for mitigating error in a quantum computing device that includes receiving a quantum circuit configuration including a plurality of quantum gates, receiving a maximum tolerable bias for a result, selecting at least one gate among plurality of quantum gates to be approximated based on the maximum tolerable bias, generating an updated quantum circuit configuration by replacing the at least one gate with an approximation based on a generalized quasi-probabilistic decomposition including a positive component and at least one remaining gate among the plurality of quantum gates other than the at least one gate being represented based on a full quasi-probabilistic decomposition including a positive component and a negative component, and executing the updated quantum circuit configuration, by the quantum computing device, to generate the result having a bias less than or equal to the maximum tolerable bias.

Another object of the present disclosure is to provide a method that includes obtaining a list of the of the plurality of quantum gates sorted based on robustness, iterating through the list, comparing gates from the list to a condition, and adding gates from the list to a first group of gates to be approximated based on the condition, and replacing the gates in the first group with implementable operations based on generalized quasi-probabilistic decompositions for executing the updated quantum circuit configuration.

An object of the present disclosure is to provide a quantum computing device that includes a memory configured to store measured expectation values, and a controller configured to receive a quantum circuit configuration including a plurality of quantum gates, generate an updated quantum circuit configuration by replacing a first gate among the plurality of quantum gates with at least one implemental quantum gate selected from among a set of implementable quantum gates based on a generalized quasi-probabilistic decomposition including a positive component and replacing a second gate among the plurality of quantum gates with at least two implemental quantum gates selected from among the set of implementable quantum gates based on a full quasi-probabilistic decomposition including a positive component and a negative component, and execute the updated quantum circuit configuration to generate an expectation value.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates a hybrid quantum-classical computer architecture according to an embodiment of the present disclosure.

FIG. 4 illustrates an example flow chart for a method of mitigating error in a quantum computing device according to an embodiment of the present disclosure.

FIG. 5 illustrates an example flow chart for a method of mitigating error in a quantum computing device according to an embodiment of the present disclosure.

FIG. 6 shows an example flow chart for obtaining a final expectation value estimate E and the bias b, using the estimated Ê_{B} according to an embodiment of the present disclosure.

FIG. 7 shows an example of a quantum circuit according to an embodiment of the present disclosure.

FIG. 8 illustrates an example of a noisy quantum circuit according to an embodiment of the present disclosure.

FIG. 9 illustrates an example flow chart for a method of mitigating error in a quantum computing device using a hybrid approach according to another embodiment of the present disclosure.

FIG. 10 illustrates an example flow chart for a method of mitigating error in a quantum computing device using the hybrid approach according to an embodiment of the present disclosure.

FIG. 11 illustrates an example flow chart for a method of mitigating error in a quantum computing device for determining which gates to approximate using their corresponding generalized quasi-probabilistic decomposition and which to represent with their corresponding full quasi-probabilistic decomposition, according to an embodiment of the present disclosure.

FIG. 12 illustrates an example flow chart for a method of mitigating error in a quantum computing device for determining which gates to approximate using their corresponding generalized quasi-probabilistic decomposition and which to represent with their corresponding full quasi-probabilistic decomposition, according to another embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through the following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Also, the term device used herein can refer to a single device or a group of multiple devices that are connected together via wired connections or wireless connections.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Quantum computing is a field of computing that utilizes the principles of quantum mechanics to process and store information. At its core are quantum bits, or qubits, which can exist in multiple states simultaneously due to superposition. Unlike classical bits, which are either 0 or 1, qubits can represent 0, 1, or any combination of both at the same time. This property allows quantum computers to perform many calculations simultaneously, potentially solving complex problems exponentially faster than classical computers.

Also, quantum computing can take advantage of any two state system, e.g., qubits can be based on the spin of an electron, photon polarization, superconducting circuits, nuclear spin, trapped ions, defects in diamond crystals, etc. Quantum computing also involves entanglement, where the states of qubits are interconnected and offer powerful computation capabilities (e.g., computations can scale exponentially by 2ⁿ where n is the number of qubits).

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

In addition, a hybrid quantum-classical computer architecture can incorporate a neural network by combining the strengths of both classical and quantum computers to solve complex problems. The quantum component of the architecture can include qubits, which are employed to execute specific quantum computations suited for tasks like quantum simulations, optimization, or solving quantum chemistry problems or material discovery (e.g., a QPU). Also, the classical part of the architecture can include one or more CPU's that can handle tasks that are not well suited for quantum processing, such as managing the overall computation, handling input and output, and running classical algorithms. Further, a neural network can be used to translate data and tasks between the CPU and the QPU, and for optimizing the system, solving for parameters and adjusting parameters (e.g., minimizing a cost function).

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

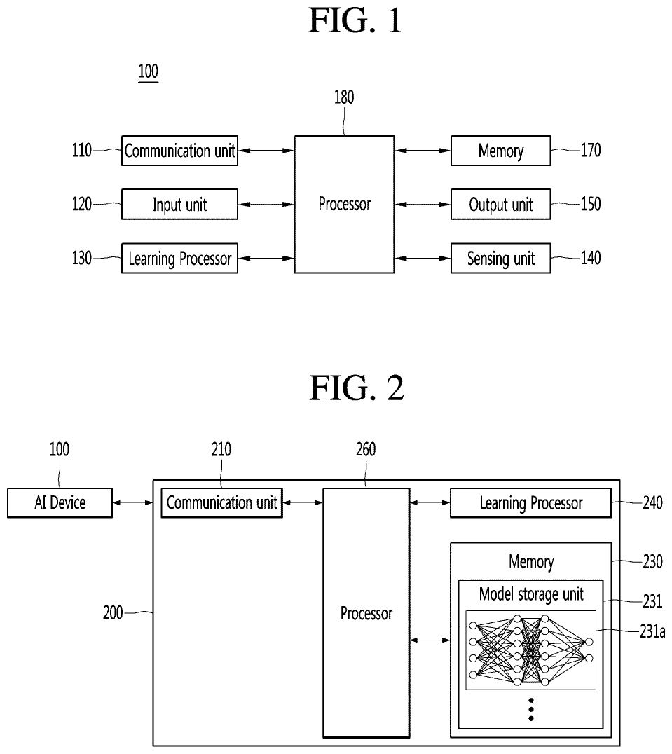

FIG. 1 illustrates an artificial intelligence (AI) device 100 which can be used as part of a hybrid quantum-classical computer architecture (e.g., the classical part), according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

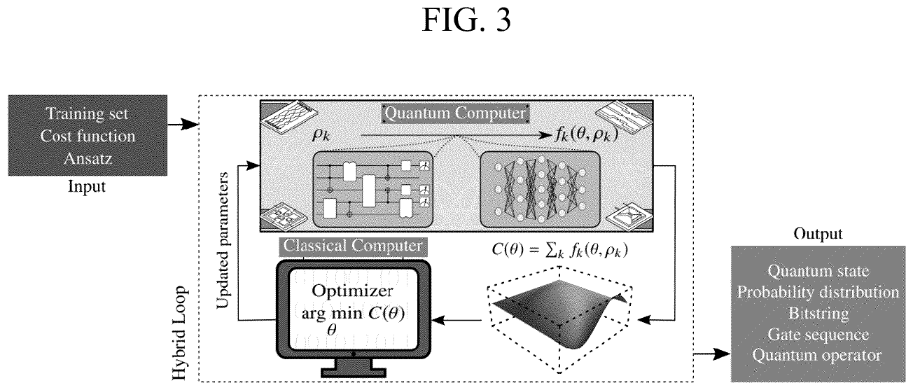

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data. For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

In addition, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

In addition, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can evaluate logic rules for solving for or finding parameters that are fed into a quantum circuit (e.g., rotation angles for quantum gates, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine an answer or a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server 200 according to one embodiment. The AI sever can implement one or more components or tasks related to the classical computing portion in the hybrid quantum-classical computer architecture.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates a hybrid quantum-classical computer architecture according to an embodiment of the present disclosure.

The hybrid quantum-classical computer architecture can include a Quantum Processing Unit (QPU) and a Classical Processing Unit (CPU) interfaced to leverage the advantages of quantum and classical computing. The QPU includes qubits capable of superposition and entanglement for executing quantum algorithms and operations to tackle complex problems with exponential speed-ups. For example, the qubits can represent multiple states simultaneously due to superposition, enabling various quantum algorithms and quantum simulations.

In addition, the CPU can manage classical computations, data input/output, and overall system control. An interface layer can be included which facilitates communication between the quantum and classical components, such as translating high-level tasks into quantum operations and vice versa. This layer includes software, firmware, and protocols for carrying out tasks, optimizing performance, and managing the hybrid system.

Quantum algorithms are run on the QPU to exploit quantum properties such as superposition and entanglement. These algorithms, such as variational quantum algorithms (VQA) and quantum chemistry simulations, can outperform classical counterparts in specific tasks. Also, control software operating on the CPU can oversee the hybrid system's operation, including error correction, noise mitigation, and optimization routines used for quantum computation.

In addition, error correction and mitigation techniques can be integrated into the architecture to address inherent noise and error rates in the quantum hardware. The hybrid architecture can also include an application layer for user interface software and algorithms, enabling interaction with the system for inputting problems, receiving results, and analyzing data.

In more detail, the classical computer can include an optimizer or optimization function, which can implement a cost function or objection function. The cost function can be optimized using various techniques, such as gradient descent, but embodiments are not limited thereto. Also, the optimizer can use various hyperparameters, such as determining how many iterations to use and how big the steps should be for use in a descent for converging on a minimum.

The hybrid quantum-classical computer architecture can be referred to as a near-term quantum computer, a noisy intermediate scale quantum (NISQ) computer or a NISQ device.

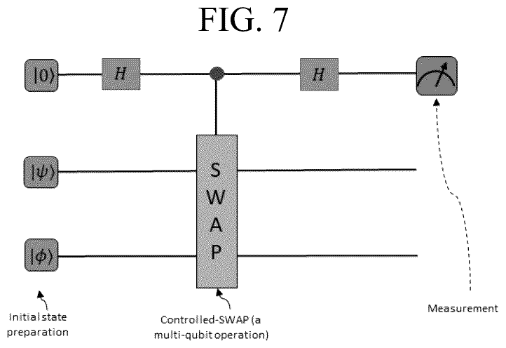

FIG. 7 shows an example of a quantum circuit that can be implemented by the QPU. The quantum circuit can include multiple qubits. The quantum circuit in FIG. 7 is an example of a short-dept quantum circuit (e.g., a SWAP circuit, to be discussed in more detail below). For example, NISQ algorithms can be designed for short-depth quantum circuits with limited numbers of qubits and gates, e.g., variational quantum algorithms (VQAs).

Also, optimization problems often arise in physics, mathematics, and computer science. The problem of finding the ground state pertaining to a Hamiltonian is one such problem which can be cast as an optimization problem. Variational quantum algorithms (VQAs) can be utilized to address this problem. VQAs can use noisy quantum computers and classical optimization to solve such optimization problems and can gain near term quantum advantage. For example, VQAs can be used in various applications such as efficiently finding the ground state of a Hamiltonian, diffusion quantum Monte Carlo, etc.

Also, various operations can be applied to the qubits in the quantum computer. For example, the operations can include rotations around certain axes, e.g., RY gates for qubit rotations, etc.

Further, measurements can be performed on the qubits. These measurements can provide information about the current state's proximity to the ground state. For example, the measured information can be used to determine how well the system is evolving towards the desired state.

In addition, based on the measurements and a given cost function, the classical computer can solve for various parameters and apply the updates to the quantum gates. In other words, the guess for finding the ground state (e.g., lowest energy state) or other parameter can be effectively refined. This can be repeated as a type of optimization loop and the system can gradually converge to the ground state.

According to embodiments, the classical computer can use an artificial intelligence (AI) model (e.g., a neural network) to solve for parameters of the quantum circuit, but embodiments are not limited thereto.

Also, it can determine whether the system converges to a desired state (e.g., the ground state). If convergence is not reached, then the process repeats and the quantum computer is updated with the new set of parameters (e.g., thetas in FIG. 3) and the quantum circuit can be run again. The process can iterate until convergence is reached and the output is a final result.

For example, a final result can be the calculated ground state of the quantum system, which can be useful for a wide range of simulations across various fields, such as quantum chemistry, material science, physics, cryptography, etc. For instance, calculating the ground state molecules provides insights into their electronic structures, bond energies, and reaction mechanisms, can be used for drug discovery, and developing new materials.

However, the final result may not be reliable due to noise that may be present in the system. To address errors due to noise, various techniques can be applied, which can be very time consuming, resource intensive and biased.

For example, removing or mitigating noise is a considerable challenge in quantum computation and communication. Quantum error correction schemes can be applied to detect and correct noise that affect quantum computation. These schemes often require some kind of encoding and decoding that can protect from noise ruining the quantum computation. However, these schemes can require thousands to millions of qubits, in order for the quantum algorithms to be able to deliver any meaningful results.

In addition, most near-term quantum algorithms are short-depth and come in the form of a hybrid quantum-classical feedback loop. Since quantum circuits do not take up a heavy load in the entire calculation, a higher noise budget can be allowed in the hybrid algorithms. A feature of such hybrid approaches is the variational method.

Characterizing target quantum systems often involves constructing trial wavefunctions with a substantial yet manageable number of variational parameters. These parameters can then be optimized to minimize the energy of the system by invoking a classical computer in the form of a feedback loop. Implicitly, this approach leverages the user's intuition and knowledge of the target system to select a parameter space that, while extensive, is significantly smaller than the full Hilbert space. The latter, of course, grows exponentially with the number of particles in the system. One major computational routine there is to compute the expectation value of some physical observables. Even with such hybrid quantum-classical algorithms, noisy quantum hardware can produce unreliable measurement outcomes of the physical observables.

Also, existing quantum error mitigation schemes often require either exponential samplings or exponential copies of quantum states, with respect to the amount of noise, to be able to attain resolvable and reliable statistics of the measurement outcome. For instance, the sampling overhead scales exponentially with the circuit depth given a desired computational accuracy. Even at relatively shallow circuit depth, a superpolynomial number of samplings is needed. Thus, a need exists for a solution that mitigates the exponential computational overhead associated with quantum error mitigation protocols while preserving reasonable accuracy.

For example, various types of quantum error mitigation (QEM) can be applied to improve the measurement outcome of the expectation value of some physical observable, such as zero-noise extrapolation (ZNE), probabilistic error cancellation (PEC) and Clifford-data regression.

In order to compare different error mitigation protocols, three parameters (to measure the performance of the protocols) can be examined that include the number of ancilla qubits used, the amount of bias present in the generated estimate, and the sampling overhead. Sampling overhead is often related to the variance. The bias and variance are defined in Equation 1 and Equation 2, below.

$$Bias = E [ \hat{O} ] - Tr [ O ρ ] \qquad [ Equation 1 ]$$

$$Var = E [ {\hat{O}}^{2} ] - {E [ \hat{O} ]}^{2} \qquad [ Equation 2 ]$$

For example, the bias-variance tradeoff involves finding a balance between an algorithm's accuracy and its ability to handle variations in data or noise. High-bias algorithms can be easier to implement but may miss crucial details, while high-variance algorithms can be rather complex but prone to inconsistencies. It is desirable to find a middle ground for an algorithm that is less computationally intensive but can still provide accurate results with an acceptable amount of bias.

Zero-noise extrapolation (ZNE) operates by systematically amplifying the noise present in a quantum computer in a controlled manner and then extrapolating the results back to the zero-noise limit (e.g., plotting a line with increased noise, and then traversing it backwards).

For example, ZNE includes running the same quantum circuit many times with different noise amplification factors, measuring the outcomes, and then fitting a curve to the data that relates the noise level to the measured quantities. By extrapolating this curve to the point where the noise is zero, the ideal outcome that would be obtained in the absence of noise can be estimated, thus mitigating the errors caused by the noisy quantum hardware.

However, while ZNE can be effective in mitigating some errors, it requires significant computational overhead due to the need to run the same quantum circuit multiple times with varying noise levels, which can make it impractical for large-scale or complex quantum circuits. Further, ZNE relies upon accurate noise models and extrapolation techniques, which may not always be readily available or applicable to specific hardware platforms. Also, the amplification of noise in ZNE can sometimes introduce new errors or exacerbate existing ones, potentially hindering the accuracy of the mitigated results, and ZNE does not address all types of errors, which may lead to biased and unreliable results.

On the other hand, probabilistic error cancellation (PEC) can produce unbiased results, but this comes at the cost of increased sampling overhead and exponential runtime. Probabilistic Error Cancellation (PEC) leverages knowledge of the noise affecting a quantum system to reduce errors in computation.

PEC can include characterizing the noise present in a quantum circuit, constructing a mathematical model, and then using this model to generate a quasi-probability distribution that describes the likelihood of different error configurations.

For example, PEC can include studying the specific types of errors that occur in the quantum computer's hardware and creating a mathematical model to predict how these errors will affect the calculations. Based on this model, PEC can add controlled “noise” to the quantum circuit (e.g., applying an inverse noise map or inverse noise matrix before or after each quantum gate). This added noise can cancel out the existing errors, similar to how noise-canceling headphones work (e.g., even though PEC and noise-canceling headphones operate on fundamentally different principles). By running the quantum circuit multiple times with different added noise patterns and averaging the results, the errors tend to cancel each other out, producing a more accurate answer.

In PEC, each unitary gate in the quantum circuit is decomposed as a quasi-probabilistic combination of the erroneous unitary gates (or a discrete set of implementable gates). Finding such a decomposition in itself can be a rather difficult problem and finding an optimal decomposition is even harder.

Further, assuming that such a decomposition can be found, then each quantum gate in the quantum circuit can be replaced with each implementable gate, and the quantum circuit can be run. By using the Monte Carlo simulation, an unbiased estimate can then be found. However, the runtime depends on a quantity called robustness which is the sum of the absolute values of the coefficients in the quasi-probabilistic decomposition.

For example, PEC requires exponential sampling overhead and exponential runtime, which can quickly become unmanageable or destroy any quantum advantage as the size of the quantum circuit becomes larger.

According to one or more embodiments of the present disclosure, the quantum computing device can apply PEC to one or more quantum gates within a quantum circuit.

In more detail, PEC can include five main steps that include characterizing the noise in a quantum circuit, creating a noise model, generating a quasi-probabilistic distribution of one or more quantum gates (e.g., including positive probability components and negative probability components), probabilistic sampling, and averaging the results.

For example, according to an embodiment, the quantum computing device can receive a quantum circuit representing a given computation to perform, and obtain a noise characterization of the quantum circuit that includes information about the types and probabilities of errors that occur during quantum gate operations. The noise characterization can be based on statistical tools and can include gate error rates, coherence times, and crosstalk data.

Further, based on the noise characterization, the quantum computing device can select or receive a noise model, or the quantum computing device can generate the noise model. The noise model can be based one or more of depolarizing noise, amplitude damping, stochastic Pauli noise, phase damping, bit-flip noise, etc. The noise model can be a mathematical model representing how the noise in the quantum circuit effects quantum states.

In addition, the quantum computing device can generate a quasi-probabilistic distribution of each quantum gate within the quantum circuit based on the selected noise model. In addition to positive probability distributions, the quasi-probabilistic distribution of a quantum gate can include negative values or complex values. The quasi-probabilistic distribution can be obtained based on the Choi matrix (e.g., Choi-Jamiołkowski isomorphism) or tomography (e.g., a density matrix based on measurements or a generalization that reconstructs the quantum channel).

Further, the quantum computing device can generate an updated quantum circuit in which each quantum gate is replaced by its corresponding quasi-probabilistic distribution (e.g., including positive and negative components). Linear algebra can be used so that the noise can be represented as a matrix that acts on the quantum state.

In addition, the quantum computing device can run the updated quantum circuit multiple times with different random variations to provide many results. According to an embodiment, Monte Carlo sampling can be used.

Then, the results of the different runs can be averaged to generate an average result corresponding to the estimated expectation value. For example, the matrices representing the noise can approximate the inverse of the noise matrix when averaged and the noise can be effectively canceled out.

In further detail, Probabilistic Error Cancellation (PEC) is an error mitigation technique that uses the knowledge of the noise occurring in the system to mitigate the errors in estimating quantities, such as Born-rule probability or expectation value of an observable. For example, PEC involves expressing the actual gate in the circuit in terms of (noisy) gates that can be implemented practically.

The set of implementable operations refers to the set of noisy operations that can be applied in an actual experimental setup. The set of noisy operations can be discrete or continuous. Also, if the noise acting in the system is known, then the basis set of implementable operations can be defined. Based on this set of implementable operations, a quasi-probabilistic decomposition of the actual gate can be found in terms of the implementable gate sets.

For example, given a single unitary quantum gate U, it is desirable to determine the expectation value of some observable O, e.g., compute Tr[OU(|0 [symbol] 0|)] with U(·)=U(·)U†. However, due to the presence of noise E, the gate U cannot be implemented ideally but instead, the noisy gate U can be implemented, which is E∘U. Thus, resulting in Tr[OE∘U(|0 [symbol] 0|)].

Further, in order to mitigate the error using PEC, the decomposition of the gate U can be obtained in terms of implementable operations. For example, let B₁, B₂ be implementable operations (that is, of the form Bᵢ=E∘Uᵢ where Uᵢ is some quantum operation), such that U=q₁B₁−q₂B₂, where q₁, q₂>0 and q₁−q₂=1. By using this decomposition, a probability distribution can be constructed of (q₁/(q₁+q₂), q₂/(q₁+q₂)).

Then, the gates B₁ and B₂ can be sampled according to this probability distribution, and the ideal/desired gate U in the circuit can be replaced with these implementable gates. Also, the expectation values of the observable O when using B₁ and B₂ can be β₁ and β₂, respectively. Therefore, using β₁ and β₂, the actual expectation value can be computed as Tr[OU(|0 [symbol] 0|)]=q₁β₁−q₂β₂. In the above example, a quasi-probabilistic decomposition is used and finding such an optimal decomposition is a hard problem by itself.

In addition, for a quantum algorithm with multiple unitary gates, the system needs to be sampled many times. By keeping a record of the coefficients and their signs, and by combining them according to the decomposition of every gate in the algorithm, then the unbiased expectation value can be obtained.

Further, the sampling size to get the unbiased estimate of the expectation value depends on the product of the absolute sum of the coefficients in the quasi-probabilistic decomposition of each gate in the quantum circuit. Also, the sampling overhead increases exponentially with the number of gates in the quantum circuit and the probability of error: M_{PEC}=(2γ²/ϵ²)ln(2/p_{fail}), where γ is the robustness, ϵ is the precision of the Monte Carlo sampling, and p_{fail} is the probability of failure for the Monte Carlo sampling algorithm. Here, γ≈e^{4Dp} with D being the circuit depth and p being the probability of gate error.

Thus, PEC can be used to obtain unbiased expectation value, but it comes at a cost of an exponential sampling overhead.

According to an embodiment, a method for mitigating error in a quantum computing device can provide a constant runtime quantum error mitigation protocol by approximating each noisy quantum gate present in the quantum circuit, thereby restricting the quantum dynamical evolution of the input quantum state. Hence, the name error mitigation by restricted evolution (EMRE).

EMRE is based on the generalized robustness measure defined for quantum operations in the context of resource theory of channels. For example, the generalized robustness can be used to find the closest (noisy) implementable circuit to the ideal quantum circuit. Using the new implementable circuit, the ideal expectation value can be estimated using constant sampling overhead. However, the estimated expectation value comes with a small non-zero bias. Also, an analytical relationship can be shown between the bias and the generalized robustness thus quantifying how bias grows with the noise in the circuit.

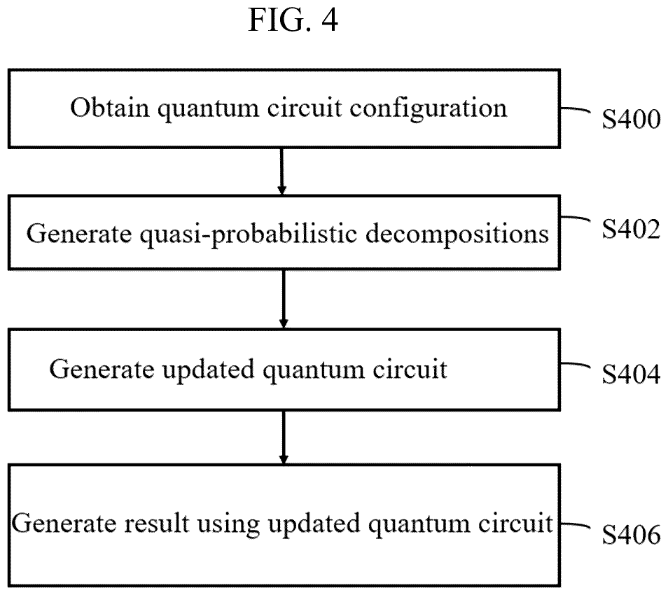

FIG. 4 shows an example flow chart of a method for mitigating error in a quantum computing device according to an embodiment of the present disclosure. For example, the quantum computing device can be configured with a method that includes receiving a quantum circuit configuration including a plurality of quantum gates (e.g., S400), and generating a plurality of quasi-probabilistic decompositions for the plurality of quantum gates, respectively, and each of the plurality of quasi-probabilistic decompositions including a positive component and a negative component (e.g., S402).

Also, the method can further include generating an updated quantum circuit configuration by replacing each of the plurality of quantum gates in the quantum circuit configuration with at least one implemental quantum gate selected from among a set of implementable quantum gates, in which the at least one implemental quantum gate corresponds to the positive component of a corresponding quasi-probabilistic decomposition (e.g., S404), and executing the updated quantum circuit configuration, by the quantum computing device, to generate an expectation value (e.g., S406). Various aspects of the method are discussed in more detail below, according to embodiments.

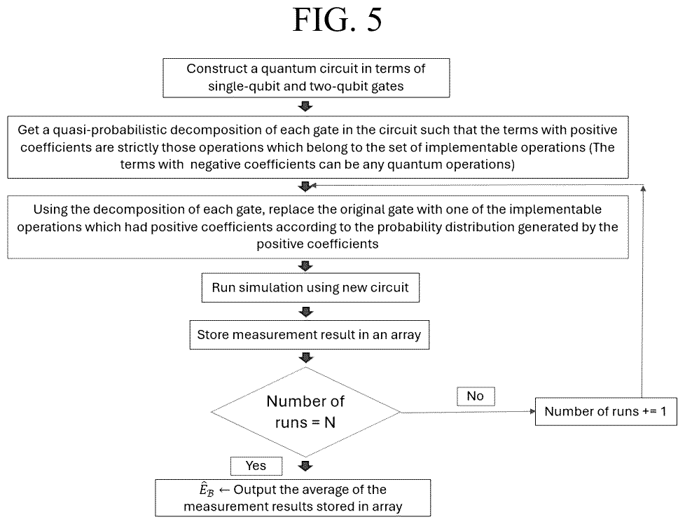

FIG. 5 shows an example flow chart of a method of controlling a quantum computing device according to an embodiment of the present disclosure.

According to an embodiment, a quantum computing device can perform error mitigation by restricted evolution (EMRE), which can include decomposing the unitary gate as a probabilistic combination of the implementable gates and some quantum channel, as shown in Equation 3 below.

$$𝒰 = ( 1 + s ) ℬ - s \qquad [ Equation 3 ]$$

In Equation 3, U is the actual quantum gate, B is a probabilistic combination of the implementable erroneous gates, and N is some quantum channel. Also, s is a coefficient, which can be used to define a measure called generalized robustness and can be used to calculate the runtime of the algorithm. The generalized robustness and runtime are discussed in more detail at a later section below. Further, the variable s needs to be greater than or equal to 0.

In addition, each quantum gate within a quantum circuit can be decomposed into a positive component (e.g., (1+s)B) and a negative component (e.g., −sN).

According to an embodiment, the negative component (e.g., −sN) can be ignored, and the original quantum gate can be approximated as B multiplied by (1+s) (e.g., an optimal decomposition can have the negative component be a very small number).

In other words, in order to drastically reduce runtime and computations, the negative component (e.g., −sN) can be ignored or discarded, and each quantum gate within a quantum circuit can be replaced by its corresponding positive component (e.g., (1+s)B), which can be represented as some convex combinations of noisy implementable gates.

In addition, the variable s in Equation 3 can be reorganized such that instead of s, new s−1 needs to be greater than 0, to produce an equivalent equation, as shown below in Equation 4.

$$𝒰 = s ℬ - ( s - 1 ) \qquad [ Equation 4 ]$$

In the above equations, B corresponds to a convex combination of noisy implementable gates and can be defined by Equation 5 below.

$$ℬ = {\sum }_{i} {p}_{i} {𝒪}_{i} \qquad [ Equation 5 ]$$

In Equation 5, β∈ [symbol] _{ε}(d) a [symbol] ∈CPTP(d), in which the sets I_{ε}(d) and CPTP(d) denote the set of implementable operations (e.g., basis of noisy operations) and completely positive and trace preserving operations, respectively, with input and output systems being d-dimensional. CPTP(d) can represent the set of all possible quantum channels.

In addition, the implementable operation(s) B can bet set as close to the actual quantum gate U as possible by setting a quantum channel N that minimizes s−1.

For example, this optimal s−1 can be referred to as generalized robustness or global robustness and can be denoted as R_{I}_{_{ε}}⁺( [symbol] ). Further, the generalized robustness or global robustness [symbol] ( [symbol] ) (e.g., optimal s−1) can be represented as an optimization problem (e.g., a minimization), as shown in Equation 6 below.

$${R}_{{ℐ}_{ε}}^{+} ( 𝒰 ) = min s - 1 \\ \text{s.t.} \frac{𝒰 + ( s - 1 )}{s} ∈ {ℐ}_{ε} ( d ) , s - 1 \geq 0 , ∈ CPTP ( d ) \qquad [ Equation 6 ]$$

In addition, the dual of the primal problem in Equation 6 can be represented an as a type of maximization optimization problem, as shown in Equation 7 below.

$${R}_{{ℐ}_{ε}}^{+} ( 𝒰 ) = sup Tr [ {J}^{u} β ] - 1 \\ \text{s.t.} : 0 \leq Tr [ {J}^{Y} β ] \leq 1 , {β}_{A} \geq 0 , Y ∈ {ℐ}_{ε} ( d ) \qquad [ Equation 7 ]$$

In the above optimization, J^{U}(J^{Y}) denote the Choi matrix of U(Y) defined as [symbol] :=id⊗ [symbol] (Φ_{d}⁺), and Φ_{d}⁺:=Σ_{i,j}|i [symbol] |⊗|i [symbol] j| is the d-dimensional unnormalized maximally entangled state. For example, J represents the Choi-Jamiolkowski map of the respective quantum channels.

For example, the d-dimensional unnormalized maximally entangled state Φ_{d}⁺ can describe two quantum systems (e.g., each with d possible states) that are as intertwined as quantum mechanics allows or has the highest possible degree of entanglement between the two systems, in which ⊗ is the tensor product for combining the basis states of the individual quantum systems. For example, measuring one system can instantly reveal the state of the other, regardless of the distance between them.

According to embodiments, in the minimization optimization problem of Equation 6 and in the maximization optimization problem of Equation 7, the value of s can be solved for by using known libraries, e.g., software frameworks and tools designed for expressing and solving optimization problems on quantum hardware (e.g., Qiskit optimization, OpenQAOA, D-Wave Ocean, etc.). Thus, having solved for s and B, the original quantum gate can be approximated as B multiplied by s (e.g., sB).

In addition, using the formulations of the generalized robustness, good upper and lower bounds can be found given a particular (but not necessarily optimal) decomposition of U based on Equation 8 below.

$$s \geq {R}^{+} ( 𝒰 ) \geq \frac{1}{{d}^{2} s} Tr [ {Φ}_{d}^{+} {J}^{{ε}^{′}} ] \qquad [ Equation 8 ]$$

For example, d is the dimension of the system on which U acts, and in the lower bound expression Φ⁺ represents the unnormalized maximally entangle state, and ε′=sB∘ [symbol] ^{†}.

In more detail, the quantum computing device can perform a method of error mitigation by restricted evolution (EMRE) by decomposing each quantum gate within the quantum circuit, in which each quantum gate is approximated and replaced with a corresponding convex combination of noisy implementable gates to generate an updated quantum circuit configuration, which is a close approximation of the original quantum circuit.

For example, a decomposition can be generated for each quantum gate, which can be restricted to only its positive components (e.g., the negative components from the decomposition can be ignored or unused when generating the updated quantum circuit configuration).

For example, an n-qubit quantum circuit with depth N can be represented by Equation 9 below.

$$𝒰 := {𝒰}_{N} ◦ … ◦ {𝒰}_{2} ◦ {𝒰}_{1} \qquad [ Equation 9 ]$$

As shown above, the n-qubit quantum circuit can be defined as quantum gate U₁, acting on quantum gate U₂, . . . , acting on quantum gate U_{N}. For example, each Uᵢ represents the i-th layer of the quantum circuit acting on n qubits. Also, for each layer i, a number sᵢ≥1 and an implementable channel Bᵢ can be found according to Equation 10 below.

$${s}_{i} {ℬ}_{i} \geq {𝒰}_{i} \qquad [ Equation 10 ]$$

According to the above, there exists a set of quantum channels {Nᵢ}ᵢ such that for each respective quantum gate Uᵢ, Equation 11 holds.

$${𝒰}_{i} = {s}_{i} {ℬ}_{i} - ( {s}_{i} - 1 ) \qquad [ Equation 11 ]$$

For example, this can be referred to as the generalized quasi-probability decomposition. By using the above decomposition for all quantum gates in the quantum circuit, the quantum circuit can be represented based on Equations 12, 13 and 14 below.

$$𝒰 = s ℬ - ( s - 1 ) , \\ where \qquad [ Equation 12 ]$$

$$s = {Π}_{i = 1}^{N} {s}_{i} , and \qquad [ Equation 13 ]$$

$$ℬ = {ℬ}_{N} ◦ … ◦ {ℬ}_{2} ◦ {ℬ}_{1} \qquad [ Equation 14 ]$$

As shown above, N is the quantum channel that includes all other combinations, and s is all of the individual coefficients sᵢ of the quantum gates multiplied together.

According to an embodiment, in order to reduce the sampling overhead and shorten the runtime, each quantum gate or unitary Uᵢ can be approximated as the corresponding positive component sᵢB. In other words, each unitary gate at the i-th layer can be replaced with Bᵢ and multiply the estimate after the measurement with sᵢ. Accordingly, the quantum circuit can be approximated with noisy implementable operations as in Equation 15 below.

$$𝒰 = s ℬ = s {ℬ}_{N} ◦ … ◦ {ℬ}_{2} ◦ {ℬ}_{1} \qquad [ Equation 15 ]$$

In addition, using the approximation in Equation 15, the quantum computing device can estimate the expectation value (e.g., E_{B}) of a Pauli observable O and a bias b according to Equation 16 below.

$$\vert {E}_{ℬ} - Tr [ O 𝒰 ( \vert 0 〉 〈 0 \vert ) ] \vert \leq b \qquad [ Equation 16 ]$$

In other words, the estimated expectation value E_{B} output by the quantum computing device can be subtracted from the actual ideal value given by the trace operation to get the bias b, in which the bias b is equal to the maximum amount of bias in the system.

Further, the bias b arises from the terms that were ignored or unused (e.g., the negative components based on N) when approximating each quantum gate in the quantum circuit to create the implementable quantum circuit (e.g., a noisy circuit).

In addition, according to an embodiment, the quantum computing device can estimate the expectation value E_{B} from the implementable quantum circuit using Monte Carlo sampling, and the estimated expectation value E_{B} can satisfy Equation 17 below.

$$\vert {E}_{ℬ} - s Tr [ O ℬ ( \vert 0 〉 〈 0 \vert ) ] \vert \leq ϵ \qquad [ Equation 17 ]$$

In Equation 17, ε can be a very small number defined as cs, in which c<<1.

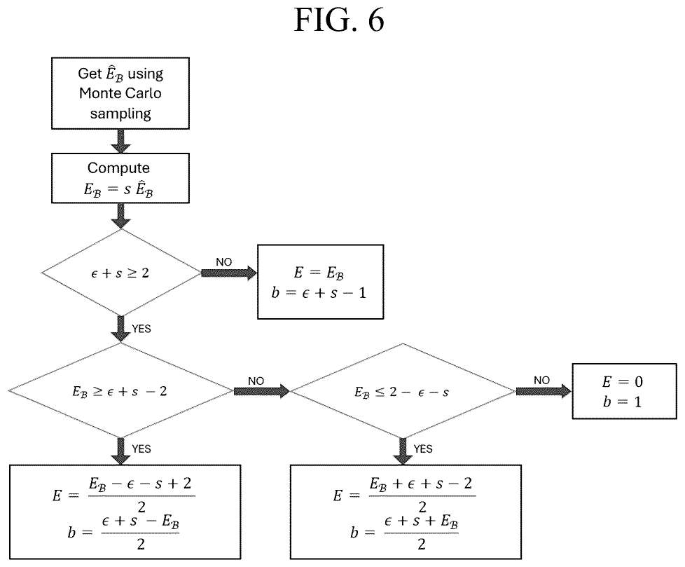

In addition, as shown by the flowchart in FIG. 6, the estimated expectation value E_{B} and the bias b can be found when E_{B}≤2−ε−s. In this situation, the estimate can be (E_{B}+ε+s−2)/2 and the bias can be (8+s+E_{B})/2 which depends on E_{B}.

Further, when the condition 2≤ε+s is violated, e.g., as in Equation 18 below, then ε+s−2≤E_{B}≤2−ε−s, and the estimated expectation value can be equal to E_{B} and the bias b can be a constant that is defined by Equation 19 below.

$$ϵ + s < 2 \qquad [ Equation 18 ]$$

$$b = ϵ + s - 1 \qquad [ Equation 19 ]$$

In addition, in order to find expectation value E_{B}, Montel Carlo sampling can be used, which can reduce the sampling overhead. For example, as shown in FIG. 6, the final expectation value and bias for the EMRE method can be obtained according to various inequality conditions being satisfied.

For example, the approximated quantum circuit (e.g., using only positive components to approximate each quantum gate) can be run multiple times and each measurement outcome can be a sample from a probability distribution. Further, the expectation value of an observable can be estimated by averaging the results of the measurements over many samples.

In addition, the sampling overhead of the quantum computing device performing error mitigation by restricted evolution (EMRE) can be determined based on the Hoeffding's inequality according to Equation 20 below, in which (1−p_{fail}) is the success probability, where p_{fail} is fixed.

$$M = \frac{2 {s}^{2}}{{ϵ}^{2}} ln ( \frac{2}{{p}_{fail}} ) = \frac{2}{{c}^{2}} ln ( \frac{2}{{p}_{fail}} ) \qquad [ Equation 20 ]$$

For example, the quantum computing device can implement the EMRE algorithm whereby approximating the original unitary gate U with the probabilistic combination of implementable operations, and subsequently performing the Monte-Carlo sampling, a biased estimate of the expectation value can be generated, in which the runtime t can be given by the maximum integer equal to or close to Equation 21 below.

$$t = 2 {c}^{- 2} log ( 2 {p}_{f}^{- 1} ) \qquad [ Equation 21 ]$$

In Equation 21, c is a constant and p_{f} is the probability of failure.

In addition, the bias can be the maximum error or deviation from the actual result given by Equation 22 below.

$$Δ = ( 1 + c ) {R}^{+} ( U ) \qquad [ Equation 22 ]$$

In Equation 22, c is the same constant in Equation 21, and R⁺(U) is the generalized robustness of the unitary channel.

In other words, the quantum computing device performing error mitigation by restricted evolution (EMRE) can have constant runtime (e.g., in contrast to exponential runtime) which is much faster and can substantially reduce the sampling overhead, while also producing an estimate of the expectation value that has a low bias or an acceptable amount of bias.

FIG. 5 shows an example flow chart for a method for performing error mitigation by restricted evolution (EMRE), according to an embodiment of the present disclosure.

For example, the process can include constructing a quantum circuit that includes single-qubit gates and two-qubit gates by a quantum computing device or receiving the quantum circuit configuration by the quantum computing device.

Then the process can proceed by the quantum computing device generating a quasi-probabilistic decomposition for each quantum gate within the quantum circuit, in which the quasi-probabilistic decomposition includes positive coefficients and negative coefficients (e.g., see Equations 3 and 4, above). For example, the positive coefficients of the decomposition are only operations that belong to a set of implementable operations (e.g., noisy implementable quantum gates), and the negative coefficients can be any quantum operations (e.g., some quantum channel N).

In more detail, for a general error ε, it is a difficult problem to find the most optimal decomposition of U such that U=sB−(s−1)N, where B denotes the probabilistic sum of implementable operations (e.g., probabilistic sum of pₐA+p_{b}B, such as 40% (pₐ) of the time it operates as implementable gate A and 60% (p_{b}) of the time it operates as implementable gate B), and N can be any quantum operation (e.g., even unimplementable operations). As discussed above with regards to Equation 5, B=ΣpᵢOᵢ, where the Oᵢ's belong to the set of implementable operations and the pᵢ's are probabilities.

In addition, to find the decomposition, the optimization problem of Equation 6 can be solved which outputs the coefficient s and the quantum operation N. Further, using the coefficient s and the quantum operation N, then the probabilistic sum of implementable operations B can be generated. Also, since the implementable operations Oᵢ's are known, then the probabilities can be found using linear algebra.

Further, the quantum computing device can use the quasi-probabilistic decomposition of each quantum gate within the quantum circuit, and replace the original quantum gate with one of the implementable operations which had positive coefficients according to the probability distribution generated by the positive coefficients. For example, the quantum computing device can generate an approximated quantum gate corresponding to the original quantum gate, which can be approximated as B multiplied by s (e.g., see Equation 15).

In addition, the quantum computing device can generate a new quantum circuit in which the original quantum gates have been replaced with their corresponding approximated gates (e.g., having only positive components), in which the negative components from the quasi-probabilistic decomposition are not used and are ignored. In other words, all of the original quantum gates in the quantum circuit can be replaced with approximated gates made up of noisy implementable operations having only positive probability components.

However, according to another embodiment (e.g., HEMRE, discussed in more detail below), the new quantum circuit can include one or more quantum gates represented by their corresponding quasi-probabilistic decomposition and one or more quantum gates represented by implementable operations having only positive probability components (e.g., the generalized quasi-probabilistic decomposition), in this way the bias can still be reduced but this can increase the sampling overhead which can lead to a non-constant runtime. However, even if the new quantum circuit is run according to a non-constant runtime, this can be manageable by keeping the number of gates represented by a quasi-probabilistic decomposition to a minimum.

Then, the quantum computing device can run the new circuit for a plurality of times (e.g., for N runs) and store the results in an array, which can be stored in a memory of the quantum computing device. The number of runs N can be input by a user or set as a default number, but embodiments are not limited thereto.

According to an embodiment, the quantum computing device can be a quantum computer, a hybrid quantum computer that implements an architecture of a classical computer and a quantum computer, or a classical computer simulating a quantum computer.

In addition, the quantum computing device can use Monte Carlo sampling for sampling results of the plurality of runs of the new quantum circuit (e.g., including the approximated gates). Upon completing the number of N runs, the quantum computing device can generate an average value of the measurement results stored in the array. The average value of the measurement can be output, such as being displayed on a display and stored in the memory. Also, the average value of the measurement can be transmitted by the quantum computing device to an external device. The average value can be the expectation value of a physical observable.

In this way, a reliable estimate of the expectation value can be generated in much less time, with drastically reduced sampling overhead, while having an acceptable amount of bias. Also, the quantum computing device implementing the EMRE method can produce an accurate and reliable estimate of the expectation value in constant runtime (e.g., with about 1,000 to 1,100 samples if the precision of the Monte Carlo simulation is set to 97%).

According to an embodiment, a method for mitigating error in a quantum computing device can include receiving a quantum circuit configuration including a plurality of quantum gates, generating a plurality of quasi-probabilistic decompositions for the plurality of quantum gates, respectively, and each of the plurality of quasi-probabilistic decompositions including a positive component and a negative component, generating an updated quantum circuit configuration by replacing each of the plurality of quantum gates in the quantum circuit configuration with at least one implemental quantum gate selected from among a set of implementable quantum gates, the at least implemental quantum gate corresponding to the positive component of a corresponding quasi-probabilistic decomposition, and executing the updated quantum circuit configuration, by the quantum computing device, to generate an expectation value.

Also, the method can include repeatedly executing, by the quantum computing device, the updated quantum circuit configuration for a predetermined number of runs to generate a plurality of expectations values, storing the plurality of expectations values corresponding to the predetermined number of runs in a memory of the quantum computing device, and outputting an average expectation value corresponding to an average of the plurality of expectations values.

In addition, according to an embodiment, the average expectation value can be generated according to a constant runtime.

Further, the method can include estimating an expectation value of a Pauli observable O (with respect to some quantum circuit U and some input state) and has a bias b according to Equation: | [symbol] −Tr[O [symbol] (|0 [symbol] 0|)]|≤b, where E_{B} is the average expectation value expectation subtracted from an actual ideal value given by a trace operation.

In addition, each of the plurality of quasi-probabilistic decompositions can based on equation U=sB−(s−1)N, where U corresponds to a quantum gate in the quantum circuit configuration, B is a probabilistic combination of implementable quantum gates, N is a quantum channel, and s is a coefficient corresponding to a generalized robustness, and the at least one implemental quantum gate selected from among the set of implementable quantum gates and included in the updated quantum circuit configuration includes sB and does not include −(s−1)N, in which sB corresponds to the positive component and −(s−1)N corresponds to the negative component.

According to an embodiment, the method can include setting the probabilistic combination of implementable quantum gates (B) to be approximately equal to the quantum gate U by setting the quantum channel N that minimizes s−1.

Also, B can be a probabilistic sum of at least two implementable operations including pₐA+p_{b}B, where A is a first implementable gate, B is a second implementable gate, pₐ is a first probability, and p_{b} is a second probability.

According to an embodiment, the set of implementable quantum gates can include a Hadamard gate, a T gate, a T-dagger gate, and a controlled-NOT gate, but embodiments at not limited thereto. For example, other types of gates can be included in the set of implementable quantum gates.

In addition, the plurality of quasi-probabilistic decompositions can be determined based on partially depolarizing noise.

Also, executing the updated quantum circuit configuration by the quantum computing device can have a runtime t based on equation: t=2c⁻² log (2p_{f}⁻¹), in which c is a constant and p_{f} is a probability of failure.

According to an embodiment, a quantum computing device can includes a memory configured to store measured expectation values, and a quantum processor including a plurality of qubits, configured to receive a quantum circuit configuration including a plurality of quantum gates, generate a plurality of quasi-probabilistic decompositions for the plurality of quantum gates, respectively, and each of the plurality of quasi-probabilistic decompositions including a positive component and a negative component, generate an updated quantum circuit configuration by replacing each of the plurality of quantum gates in the quantum circuit configuration with at least one implemental quantum gate selected from among a set of implementable quantum gates, the at least implemental quantum gate corresponding to the positive component of a corresponding quasi-probabilistic decomposition, and execute the updated quantum circuit configuration to generate an expectation value.

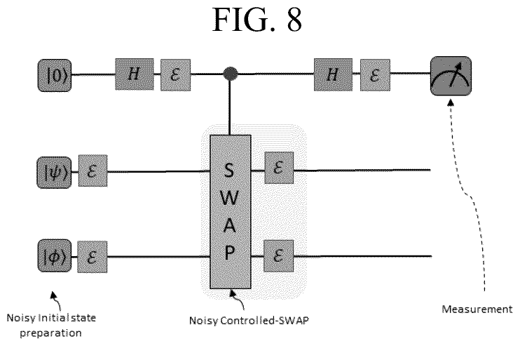

With reference to FIGS. 7 and 8, an example quantum circuit simulation is shown which can be used by the quantum computing device implementing the EMRE method.

FIG. 7. Shows an example quantum circuit for implementing the SWAP test which can be used to test how much two quantum states differ from each other. For example, the SWAP test is an algorithm that can determine the similarity or overlap between two quantum states.

An auxiliary qubit (ancilla) can be used to control a SWAP gate, which exchanges the states of the two qubits being compared. After applying Hadamard gates to the ancilla qubit before and after the controlled-SWAP gate, a measurement of the ancilla qubit reveals information about the overlap between the two states. The probability of measuring the ancilla in the state |0 [symbol] is directly related to the squared magnitude of the inner product between the two states, thus quantifying their similarity.

In more detail, the circuit shown in FIG. 7 can be used to check how much the states |ψ [symbol] and |φ [symbol] differ from each other. The controlled-SWAP operation is a multiple-qubit operation. If the states |ψ [symbol] and |φ [symbol] are 3-qubit states each, the in actual experimental implementation, the C-SWAP gate is implemented using about 130 single and two-qubit gates, which are the Hadamard gate, T gate, T-dagger gate, and the controlled-NOT gate. For example, these gates (H, T, T-dagger, CNOT) form the basis of the implementable gates.

In addition, upon measurement, the output is a probability of getting 0 and 1, which can be referred to as probability p₀ and probability p₁, respectively. Then, using these probabilities, it can be quantified how much both states differ from each other.

Further in this example, using the probability p₀ and the probability p₁, the expectation value of the Z observable can be computed by subtracting the probability p₁ from the probability p₀ (e.g., p₀−p₁).

However, since quantum hardware is noisy, experimental implementation of this circuit will involve noisy gates. As shown in FIG. 8, to simulate the effect of noise on the measurement result, the noise is assumed to act after every gate in the circuit (e.g., ε).

For example, for the specific situation of partially depolarizing noise, an ideal gate G in the circuit can be decomposed as G(·)=[4/(4−3p)]DG(·)−[p/(4−3p)](XG(·)+YG(·)+ZG(·)), and the approximation for the ideal G is the erroneous G itself (multiplied by a factor).

According to an embodiment, the quantum computing device can implement an error mitigation by restricted evolution (EMRE) method that includes a process of repeating the following actions for a fixed number of steps N, in which at each step, the quantum gate is replaced with its approximated gate that is chosen from the probability distribution obtained from only the positive terms in the decomposition, and for each circuit run or simulation, the measurement result is stored in memory (e.g., in an array or other data structure) and then the quantum computing device evaluates the average after all the circuit runs, and the average can be output as the expectation value.

In this way, quantum computing device can more quickly and reliably determine the expectation value in constant runtime while still having an acceptable amount of bias.

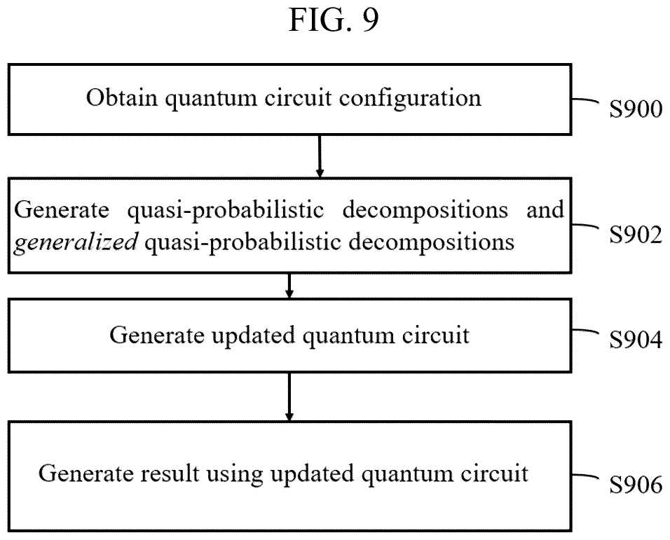

According to another embodiment of the present disclosure, FIG. 9 shows an example flow chart of a method for performing hybrid error mitigation by restricted evolution (HEMRE) in a quantum computing device. In HEMRE, at least one quantum gate within a quantum circuit configuration can be represented based on the full quasi-probabilistic decomposition (e.g., using positive and negative components based on PEC) and at least one other quantum gate within the quantum circuit configuration can be estimated or approximated using error mitigation by restricted evolution (EMRE) (e.g., using only the positive component while ignoring the negative component).

Further, the number of gates estimated using the generalized quasi-probabilistic decomposition can be adjusted based on a predetermined amount of maximum tolerable bias (e.g., the higher the allowable bias, then more gates can be approximated using the generalized quasi-probabilistic decomposition), but embodiments are not limited thereto. For example, according to another embodiment, the number of gates estimated using the generalized quasi-probabilistic decomposition can be adjusted based on minimizing bias given a predetermined sampling overhead (e.g., fixed total overhead). According to embodiments, the maximum tolerable bias and predetermined sampling overhead can be input by the user.

For example, the quantum computing device can be configured with a method that includes receiving a quantum circuit configuration including a plurality of quantum gates (e.g., S900), and generating a full quasi-probabilistic decomposition for one or more of the quantum gates in the quantum circuit configuration (e.g., including a positive component and a negative component) and a generalized quasi-probabilistic decomposition for one or more other quantum gates in the quantum circuit configuration (e.g., including only positive components) (e.g., S902).

Also, the method can further include generating an updated quantum circuit configuration by replacing one or more of the quantum gates in the quantum circuit configuration with at least one implemental quantum gate selected from among a set of implementable quantum gates, in which the at least one implemental quantum gate corresponds to the positive component of a corresponding quasi-probabilistic decomposition, and keeping the full quasi-probabilistic decomposition (e.g., positive and negative components) for one or more other gates in the circuit (e.g., S904).

The method further includes executing the updated quantum circuit configuration, by the quantum computing device, to generate an expectation value (e.g., S906). According to embodiments, different techniques can be used to determine which gates will be represented based on their corresponding full quasi-probabilistic decomposition (e.g., positive and negative components) and which gates to be estimated or approximated based on their corresponding generalized quasi-probabilistic decomposition (e.g., only positive components). Various aspects of HEMRE are discussed in more detail below, according to embodiments.

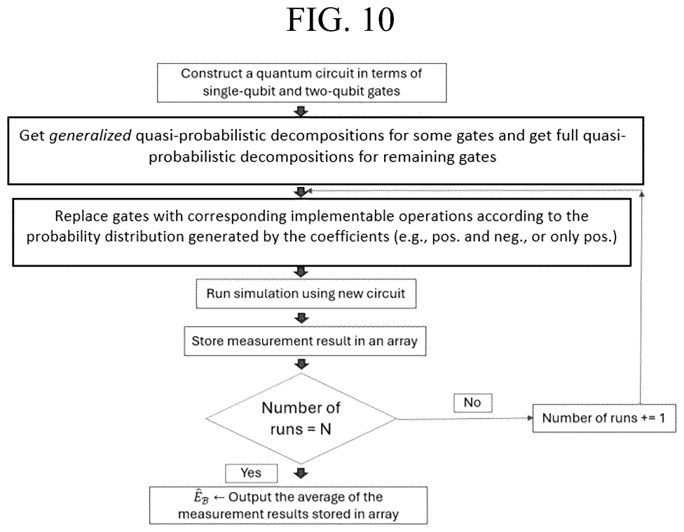

FIG. 10 shows an example flow chart for a method of performing hybrid error mitigation by restricted evolution (EMRE), according to an embodiment of the present disclosure.

For example, the process can include constructing a quantum circuit that includes single-qubit gates and two-qubit gates by a quantum computing device or receiving the quantum circuit configuration by the quantum computing device.

Then the process can proceed by the quantum computing device generating a generalized quasi-probabilistic decomposition for some quantum gates (e.g., one or more) within the quantum circuit, in which the generalized quasi-probabilistic decomposition includes only positive coefficients, and generating a full quasi-probabilistic decomposition for the remaining quantum gates (e.g., one or more) within the quantum circuit, in which the full quasi-probabilistic decomposition includes positive coefficients and negative coefficients.

Further, the quantum computing device can use the corresponding decompositions of the quantum gates within the quantum circuit, and replace the original quantum gates with one or more of the implementable operations based on the coefficients from the decompositions.

In addition, the quantum computing device can generate a new quantum circuit in which the original quantum gates have been replaced with their corresponding approximated gates (e.g., some having only positive components, and remaining ones having both positive and negative components). In other words, all of the original quantum gates in the quantum circuit can be replaced with approximated gates made up of noisy implementable operations.

Then, the quantum computing device can run the new circuit for a plurality of times (e.g., for N runs), perform sampling (e.g., Monte Carlo sampling), and store the results in an array, which can be stored in a memory of the quantum computing device. The number of runs N can be input by a user or set as a default number, but embodiments are not limited thereto.

In this way, a reliable estimate of the expectation value can be generated in much less time than the PEC method with drastically reduced sampling overhead, but more time than EMRE, while having an acceptable amount of bias that is lower than the bias associated with EMRE. Also, the quantum computing device implementing HEMRE can produce an accurate and reliable estimate of the expectation value with a runtime much less than that of PEC according to embodiments.

According to an embodiment, the quantum computing device can implement a hybrid error mitigation by restricted evolution (HEMRE) method that includes a process of repeating the following actions for a fixed number of steps N, in which at each step, the quantum gate is replaced with its approximated gate that is chosen from the probability distribution obtained from the terms in its corresponding decomposition (e.g., either the generalized quasi-probabilistic decomposition or the full quasi-probabilistic decomposition), and for each circuit run or simulation, the measurement result is stored in memory (e.g., in an array or other data structure) and then the quantum computing device evaluates the average after all the circuit runs, and the average can be output as the expectation value.

For example, for purposes of explanation, assume a quantum circuit configuration only includes two quantum gates, gate G1 and gate G2. In response to receiving an input maximum tolerable bias, it can be determined that gate G1 can be represented according to its full quasi-probabilistic decomposition and gate G2 can be approximated according to its generalized quasi-probabilistic decomposition. In other words, the maximum tolerable bias may be high enough that it allows for one of the two gates to be approximated with its generalized quasi-probabilistic decomposition, rather than representing both gates with their corresponding full quasi-probabilistic decompositions which would require a larger sampling overhead.

In other words, using the full quasi-probabilistic decompositions for gates can produce a result with little to no bias, but requires more sampling and a long run time (e.g., exponential), while using the generalized quasi-probabilistic decompositions for gates can produce a result with much less sampling but the result will have a certain amount of bias.

According to embodiments, different selection processes can be used for determining which gates to be approximated using their corresponding generalized quasi-probabilistic decomposition, and which gates to be represented by their corresponding full quasi-probabilistic decomposition.

Further in this example, gate G1 can be set equal to the decomposition of aU₁+bU₂−cU₃−dU₄ (e.g., positive and negative components), and gate G2 is approximated using the decomposition xV₁+yV₂+zV₃ (e.g., only positive components), where coefficients a, b, c, d, x, y, z are positive constants such that a+b−c−d=1 and x+y+z=1, and U₁, U₂, U₃, U₄, V₁, V₂, V₃ are implementable operations (e.g., noisy implementable quantum gates).

In addition, for running a simulation using the new circuit, gate G1 and gate G2 are replaced with the implementable operations based on their corresponding decompositions, above.

In order to illustrate this example further, let the sum s=a+b+c+d. Then, from the coefficients of the full quasi-probabilistic decomposition of gate G1, the following probability distribution can be created: [a/s, b/s, c/s, d/s]. For gate G2, x, y and z are already positive and sum to one, and thus already form a probability distribution.

Further in this example, using the probability distributions, for a simulation run, sampling can be performed for the implementable gates U₁, U₂, U₃, U4 with respective probabilities a/s, b/s, c/s, d/s, to replace the gate G1, in each simulation circuit run. Similarly, sampling can be performed for implementable gates V₁, V₂, V₃ with respect probabilities x, y, z, to replace the gate G2 in each circuit run.

For example, if x is 0.2, y is 0.3 and z is 0.5, then during the simulation runs, gate G2 can be replaced with noisy implementable gate V₁ for 20% of the times, replaced with noisy implementable gate V₂ for 30% of the times, and replaced with noisy implementable gate V₃ for 50% of the times, according to the probabilities.

Then, according to the above, the new circuit can be simulated and sampled for a number of runs=N, in which N can be a predetermined number (e.g., N can be input by the user, determined based on the maximum tolerable bias or based on a desired sampling overhead). The result after each circuit simulation run can be stored in an array in memory or other data structure, and the average of all the results can be taken and output as the estimated expectation value of the quantum circuit.

According to an embodiment, the determination for deciding which gates to be replaced with the generalized quasi-probabilistic decomposition and which gates to be represented using the full quasi-probabilistic decomposition can be determined based on a maximum tolerable bias, in order to maximize the number of gates that are to be approximated using their generalized quasi-probabilistic decomposition to reduce the sampling overhead given a desired minimum precision in estimating the result.

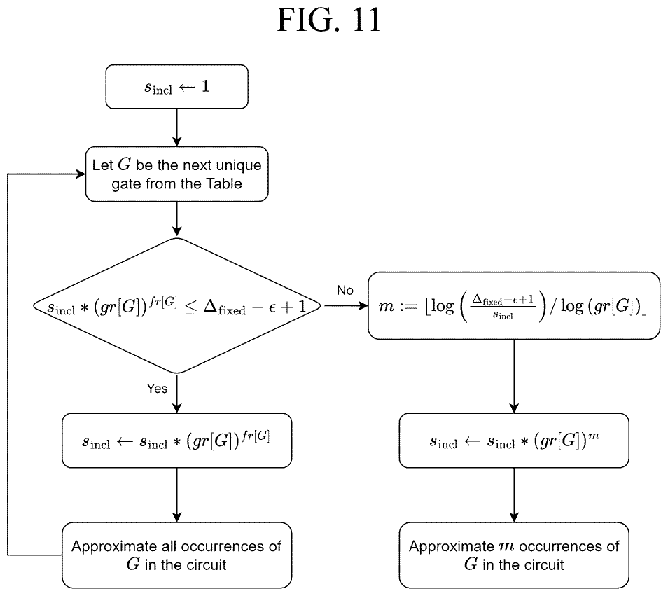

For example, with reference FIG. 11 and Algorithm 1 below, the maximum tolerable bias can be treated as a parameter for determining which gates to approximate. The maximum tolerable bias can be input by a user, but embodiments are not limited thereto.

Algorithm 1
Algorithm1 An algorithm to approximate maximum
number of gates for HEMRE

```
Input: i. Maximum tolerable bias, Δ_{fixed},
  ii. Gates′ information (as in Table I) sorted in increasing
  order of the generalized robustness.
Pre-computation:
  i. Create a frequency dictionary, say fr = {gate:frequency},
  containing the frequency of occurrence of corresponding
  gates in the circuit
  ii. Create another dictionary, gr = {gate:generalized robustness},
  containing the generalized robustness of corresponding gates.
Output: all the gates that need to be replaced, and the
  corresponding total [symbol]
  1: [symbol]
  2: for gate in unique_gates do
  3:  if [symbol]     * (gr[gates] [symbol]     + 1 then
  4: [symbol]     (gr[gates]) [symbol]
  5:  Approximate all occurrences of [symbol]     in the circuit
  6: else
$\text{7:} m = ⌊ log ( \frac{{Δ}_{fixed} - s + 1}{{s}_{incl}} ) / log ( gr [ gate ] ) ⌋$
  8: [symbol]
  9:  Approximate m occurrences of [symbol]     in the circuit
10:  Return [symbol]
indicates data missing or illegible when filed
```

Algorithm 1 can include determining which gates within the quantum circuit to be approximated with the closest implementable gates such that the bias in the result does not exceed the maximum tolerable bias Δ_{fixed}.

For example, the bias depends on the generalized robustness of the gates in the quantum circuit. Thus, a constraint can be placed on the product of the generalized robustness of the gates that will be approximated. Then, using this constraint, gates which obey the constraint can be identified and these gates can be approximated based on their closest implementable gates or a convex combination thereof (e.g., the generalized quasi-probabilistic decomposition), while the remaining gates in the circuit get represented with their full quasi-probabilistic decomposition.

Further in this example, the sampling overhead is proportional to the square of the product of the robustness or the generalized robustness of the gates in the circuit. Here, Algorithm 1 selectively chooses to keep the full quasi-probabilistic decomposition for some gates while the other gates are approximated using their generalized quasi-probabilistic decomposition, and this selection depends on the maximum tolerable bias Δ_{fixed} (e.g., input by the user).

Further, by using Monte-Carlo sampling to estimate the expectation value up to precision ϵ with success probability 1−p_{fail}, where ϵ=cs, s is the product of the generalized robustness of all gates in the circuit. Then, the sampling overhead M_{HEMRE} can be determined by Equation 23, below.

$${M}_{HEMRE} = \frac{2 {s}_{incl}^{2} {γ}_{incl}^{2}}{{( cs )}^{2}} ln ( \frac{2}{{p}_{fail}} ) \qquad [ Equation 23 ]$$

In Equation 23, γ_{incl} is the product of the robustness of the gates whose full quasi-probabilistic decomposition are chosen, and s_{incl} is the product of the generalized robustness of the gates whose generalized quasi-probabilistic decomposition are chosen.

Further, the bias for the case when ϵ+s_{incl}≥2 depends on E_{B}. Since Algorithm 1 first chooses which gates to be approximated, the case where ϵ+s_{incl}<2 can be used to put a constraint on s_{incl}, the product of the robustness of the gates to be approximated. Further, the bias is ϵ+s_{incl}−1 and this value cannot to be more than the maximum tolerable bias, Δ_{fixed}. Therefore, the constraint on the product of the generalized robustness, s_{incl}, of the approximated gates can be determined by Equation 24, below.

$${s}_{incl} \leq {Δ}_{fixed} + 1 - ϵ \qquad [ Equation 24 ]$$

Thus, the selection of which gates to be approximated using their generalized quasi-probabilistic decomposition can be determined based on the constraint in Equation 24, and the remaining gates can be represented using their full quasi-probabilistic decomposition.

According to Algorithm 1, in order to maximize the number of gates to be approximated to the closest (convex combination of) implementable gate(s) for HEMRE, the number of unique gates in the circuit can be identified and the generalized robustness can be computed for each unique gate in the quantum circuit. This information can be stored in a sorted index or table, as shown in Table I below.

TABLE I

| Gate | Frequency | Gen. robustness |
|---|---|---|
| [symbol] ₁ | n₁ | s₁ |
| [symbol] ₂ | n₂ | s₂ |
| [symbol] ₃ | n₃ | s₃ |
| [symbol] ₄ | n₄ | s₄ |

For example, the table can be sorted according to the generalized robustness such that s₁≤s₂≤s₃≤ . . . sₙ. The sorted table can be used find which gates and how many of those gates are required such that the product of their generalized robustness meet the criterion in Eq. (24). Algorithm 1 provides selecting the maximum number of gates to be approximated such that approximating just one more extra gate will violate the constraint of Eq. (24). Then, for the remainder of the gates within the quantum circuit, their full quasi-probabilistic decomposition is used for the simulation runs.

In this way, by first restricting gates with the smallest generalized robustness, it allows for more gates to be approximated without losing much information per approximated gate. For instance, for a gate having less generalized robustness, the ratio between the norm of the positive part and the negative part norm will be bigger as compared to that of a gate with larger generalized robustness. In other words, for the gate with smaller generalized robustness, the quantum operation that can be obtained by normalizing the positive part of the gate's decomposition is much closer to the original gate (in diamond norm) as compared to the quantum operation that can be obtained by normalizing the positive part of a gate having higher generalized robustness. Thus, restricting a gate with a larger generalized robustness (e.g., limiting it to its positive part), the approximation is not very close to the original gate (e.g., more information is lost) and thus, it can be more beneficial to restrict the gates that have smaller generalized robustness (e.g., less information is lost).

In more detail, with reference to FIG. 11, according to an embodiment, a method for performing hybrid error mitigation by restricted evolution (HEMRE) in a quantum computing device can include obtaining a quantum circuit configuration, a maximum tolerable bias Δ_{fixed} (e.g., input by the user), and an index including the unique quantum gates present in the quantum circuit, a corresponding frequency indicating the number of times each unique gate occurs in the circuit and a generalized robustness s, in which the gates are sorted in increasing order of their corresponding generalized robustness (e.g., from smallest to greatest).

Further, the method can include initializing a value representing the amount of generalized robustness to be included, s_{incl}, to 1, but embodiments are not limited thereto. For example, if no gate is to be approximated and all gates are to be represented with their full quasi-probabilistic decomposition, then s_{incl} will be equal to 1.

Then, the next unique gate can be retrieved from the index and the contribution of its corresponding generalized robustness can be evaluated with a condition. The evaluation condition can be s_{incl}*(gr[G])^{fr[G]}≤Δ_{fixed}−ϵ+1, wherein ϵ is the precision of the sampling algorithm (e.g., a very small non-zero value (pre-determined)), but embodiments are not limited thereto and other conditions can be considered or modified. For example, according to another embodiment, ϵ can be omitted or ignored.

For example, the current value of representing the amount generalized robustness to be included up to that point, s_{incl}, can be multiplied by the generalized robustness of the unique gate selected from the index raised to the exponent of the frequency of that selected gate (e.g., gr[G])^{fr[G]}), which can be compared to Δ_{fixed}−ϵ+1, in order to determine if all instances of that gate in the circuit can be approximated using the generalized quasi-probabilistic decomposition.

If the condition (e.g., ≤Δ_{fixed}−ϵ+1) is satisfied (e.g., the “Yes” path in FIG. 11), then all instances of that selected gate within the quantum circuit can be replaced with the corresponding generalized quasi-probabilistic decomposition (e.g., positive components), and the value representing the amount of generalized robustness to be included, s_{incl}, is updated to include that gate's contribution (e.g., the current version of Sind is multiplied by gr[G])^{fr[G]}), and the next gate having the next lowest generalized robustness within the index is selected for evaluation.

Further in this example, the process iteratively repeats through the sorted index and evaluates each next gate against the updated condition, and the corresponding gates are replaced with the corresponding generalized quasi-probabilistic decomposition, until the condition is violated (e.g., the “No” path in FIG. 11).

When the condition is violated (e.g., the “No” path in FIG. 11), that means that all instances of the currently selected unique gate that is being evaluated cannot be replaced with the corresponding generalized quasi-probabilistic decomposition (e.g., positive components), because doing so would result in a bias that is greater than the maximum tolerable bias Δ_{fixed} (e.g., input by the user). In this situation, the method can optionally include checking whether some of instances that gate within the circuit can be replaced. For example, if gate G₄ occurs 5 times in the circuit, maybe 1 of those gates could be replaced with the generalized quasi-probabilistic decomposition while still keeping the bias of the circuit less than the maximum tolerable bias Δ_{fixed}.

In this situation, according to an embodiment, the method can further include an additional check to see if less than all of the instances of the next selected gate can be approximated. This check can include calculating m:=[log((Δ_{fixed}−ϵ+1)/s_{incl})/log(gr[G])], and if m is one or more, than m indicates how many instances of next selected gate can be approximated in the circuit, and the current value representing the amount generalized robustness to be included, s_{incl}, is updated to include the contribution of those approximated gates (e.g., the current version of s_{incl} is multiplied by gr[G])^{m} to provide the updated s_{incl}).

For example, if m equals two, and gate G₄ occurs five times in the circuit, then two instances of gate G₄ can be replaced with the generalized quasi-probabilistic decomposition while three instances of gate G₄ will be represented by the full quasi-probabilistic decomposition, during the sampling runs. After the condition m is checked, then the approximation selection process can complete, and any remaining gates within the index that have not been included in the approximation process will be represented by their corresponding full quasi-probabilistic decomposition, during the sampling runs.

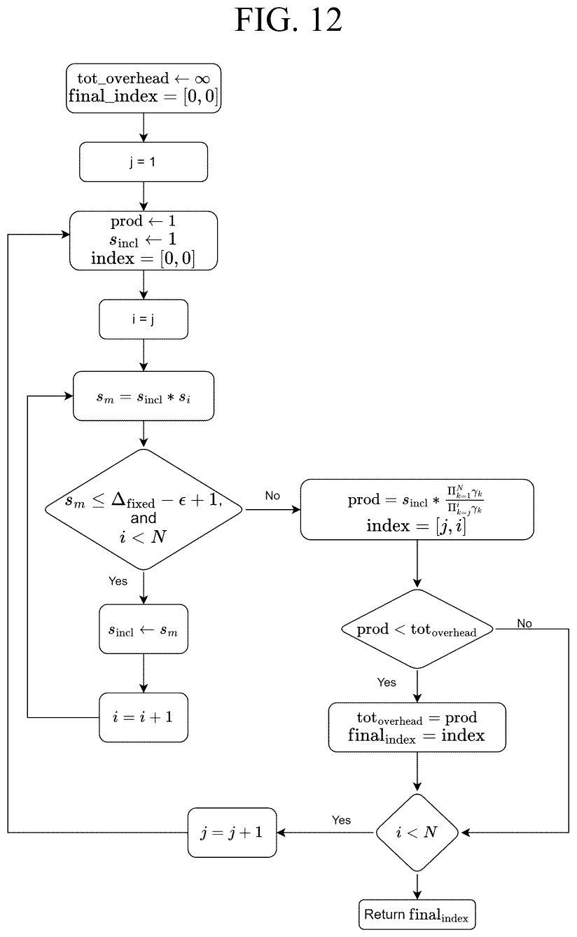

According to another embodiment, with reference to Algorithm 2 below and FIG. 12, a method for performing hybrid error mitigation by restricted evolution (HEMRE) in a quantum computing device can determine which gates to approximate in order to minimize the total sampling overhead given a maximum tolerable bias Δ_{fixed} based on different ranges of gates, without considering how many times each unique gate occurs in the circuit (e.g., frequency not considered).

```
Algorithm 2
  1: tot_overhead ← ∞
  2: final_index = [0, 0]
  3: for j = (1:N) do
  4:  prod ← 1
  5:  s_{incl} ← 1
  6:  index =[0, 0]
  7:  for i = (j:N) do
  8:  sₘ = s_{incl} * [symbol]
  9:  if sₘ ≤ Δ_{fixed} − ϵ + 1 and i < N then
10:  s_{incl} = sₘ
11:  else
$12: prod = {s}_{incl} * \frac{{Π}_{k = i}^{N} {γ}_{k}}{{Π}_{k = j}^{i} {γ}_{k}}$
13:  index= [j, i]
14:  if prod < tot_{overhead} then
15:  tot_{overhead} = prod
16:  final_index = index
17:  if i < N then
18:  break
19:  else
20:  return [symbol]
indicates data missing or illegible when filed
```

Algorithm 2 can include obtaining an index of the gates within the circuit that are sorted based on their generalized robustness in decreasing order, and then determining which gates to be approximated based on their individual generalized robustness (e.g., sᵢ).

Algorithm 2 can be useful for situations where the same gates do not occur multiple times in the circuit (e.g., when the circuit includes mostly unique gates). Quantum circuits made up of mostly unique gates are often used in noisy quantum algorithms or variational quantum algorithms where the quantum gates are parametrized, e.g., depend on a parameter. Thus, for each quantum gate within the quantum circuit there is a different parameter and each gate acts like a unique or different unitary gate.

For example, the gates and their corresponding generalized robustness can be stored in a sorted index in memory or table, as shown in Table II below. According to an embodiment, the sorted information can be stored in an array.

TABLE II

| Gate | Gen. robustness |
|---|---|
| [symbol] ₁ | s₁ |
| [symbol] ₂ | s₂ |
| [symbol] ₃ | s₃ |
| [symbol] ₄ | s₄ |

For example, the table can be sorted according to the generalized robustness such that s₁≥s₂≥s₃≥ . . . sₙ. The sorted table can be used to select ranges of gates to approximate by comparing the total sampling overhead for circuit configuration using different ranges of gates to approximate, starting with the gates that have the largest generalized robustness.

In other words, the method can include comparing at least a first sampling overhead associated with a first range of approximated gates (e.g., approximating gates G₁ through G₃) given a maximum tolerable bias Δ_{fixed} with a second sampling overhead associated with a second range of approximated gates (e.g., approximating gates G₂ through G₄) given the maximum tolerable bias Δ_{fixed}, in order to determine which ranges of gates should be approximated when performing the circuit simulations runs to best reduce the sampling overhead while staying less than or equal to the maximum tolerable bias Δ_{fixed}. The range comparisons can iteratively proceed through an array in a sliding window type of fashion.

For example, the method according to Algorithm 2 can include two nested loops, a first loop for building a current range of gates from the sorted index and calculating the sampling overhead associated with that current range, and a second loop for comparing the sampling overhead associated with that current range to the sampling overhead associated with a previously examined range of gates, and if the current range has a lower sampling overhead, then the process advances through the index to build a next range of gates and compares its sampling overhead with the previous range, and so on, in order to find the range of gates to approximate that has the lowest sampling overhead given the maximum tolerable bias Δ_{fixed}.

Further, the output of Algorithm 2 can be a range of gates that will be approximated. For example, a two-value variable called final_{index} which stores the range of gates to approximate, but embodiments are not limited thereto. For instance, if N=5 and final_{index}=[2,4], then only gate G₂, gate G₃, and gate G₄ will be approximated using their corresponding generalized quasi-probabilistic decomposition (e.g., positive components).

In more detail, with reference to FIG. 12, the method can include an initialization step that initializes a value corresponding to a total sampling overhead (up to that evaluation point) to infinity (e.g., tot_{overhead}<∞). When tot_{overhead} is set to infinity, this represents a situation where none of the gates within the quantum circuit are approximated, indicating that the sampling overhead would be exponential since all the gates will be represented with their full quasi-probabilistic decomposition (e.g., positive and negative components).

Also, the initialization step can include initializing the final range of gates to be approximated to the empty set (e.g., final_{index}=[0,0]). Also, the initialization step can include setting a variable j=1, which can be used to advance a sliding window for building a range of gates. For example, variable j can be a pointer into an array of the sorted gates.

In addition, the method can include another the initialization step, in which a variable (e.g., prod) corresponding to the product of all the robustness of both included approximated gates (e.g., s's) and non-approximated gates (e.g., γ's) up to an evaluation point to 1 (e.g., prod<−1), a variable corresponding to the product of just the generalized robustness of only the included approximated gates up to an evaluation point to 1 (e.g., s_{incl}<−1), and a current working index can be set to the empty set (e.g., index=[0,0]). For example, 1 is the smallest value that the generalized robustness (e.g., s_{incl}) of included approximated gates can be.

Then, the method can proceed to setting i=j, in order to start building a new range of gates from the sorted index. For example, the gate having the next highest generalized robustness (e.g., sᵢ) is selected from the sorted index, and i corresponds to the end of a current range or the last selected gate at that evaluation point.

Then, the building of a range of gates begins, starting from the gate having the next highest generalized robustness selected from the sorted index, and a working generalized robustness sₘ is calculated for that range (e.g., sₘ=s_{incl}*sᵢ) and then a next gate is added to that range (e.g., i=i+1) to build the range further until a condition is violated (e.g., sₘ≤Δ_{fixed}−ϵ+1, and i<N), and the included generalized robustness (e.g., s_{incl}) of only the included approximated gates up to that evaluation point is updated based on the working generalized robustness sₘ accordingly (e.g., s_{incl}<−sₘ). For example, the loop repeats until the condition is violated (e.g., sₘ≤Δ_{fixed}−ϵ+1, and i<N).

Once the condition is violated, building of that current range of gates completes [e.g., index=[j,i]], and the product (e.g., prod) of all the generalized robustness (e.g., s) of the included approximated gates of that range and all the non-generalized robustness (e.g., γ) of non-approximated gates up to that evaluation point is calculated

$$( \text{e.g.} , prod = {s}_{incl} {*}^{\frac{{Π}_{k = 1}^{N} γk}{{Π}_{k = j}^{i} γk}} ) .$$

Then the current evaluated sampling overhead, e.g., the product of all the generalized robustness and all the non-generalized robustness (e.g., prod), is compared to the value of the total sampling overhead, in which the total sampling overhead is associated with the previously evaluated range of gates, except for during the first pass when tot_{overhead}=∞. In other words, the sampling overhead for the quantum circuit given the previous range of gates to be approximated is compared with the sampling overhead for the quantum circuit given the currently evaluated range of gates to be approximated (e.g., prod<tot_{overhead}).

Based on this comparison, if this current range of gates to be approximated is better than the previous configuration, then the total sampling overhead for the circuit configuration tot_{overhead} is replaced with product of all the generalized robustness and all the non-generalized robustness corresponding to the current range of gates (e.g., tot_{overhead}=prod), and the final range of gates to approximate is set equal to the current range of gates (e.g., final_{index}=index). And the process continues to evaluate the next range of gates from the sorted index by obtaining the gate with the next highest generalized robustness (e.g., the sliding window can be advanced through a sorted array of gates), until the end of the index is reached.

Otherwise, meaning the current range of gates has worse sampling overhead, then the process completes, and the final_{index} is returned as the output (e.g., it does not get updated with the last evaluated range of gates). And the final_{index} can be a two-value variable storing the range of gates to approximate (e.g., if N=5 and final_{index}=[3,5], then only gate G₃, gate G₄, and gate G₅ will be approximated using their corresponding generalized quasi-probabilistic decomposition and gate G₁ and gate G₂ will be represented with their corresponding full quasi-probabilistic decomposition.

In this way, the method can achieve a bias that is close to (and still less than or equal to) the maximum allowed bias and a much reduced sampling overhead verses PEC.

As shown in Table III below, experimental results were generated for comparing probabilistic error cancellation (PEC) as a comparative example, the error mitigation by restricted evolution (EMRE) method, and the hybrid mitigation by restricted evolution (HEMRE) method.

For example, the below results were obtained using probabilistic error cancellation (PEC) with 1,000 samplings, EMRE with 1,000 samples and HEMRE with 1,000 samples on the same SWAP-test circuit. The SWAP-test circuit used has 7 qubits and 140 gates, and it compared the GHZ-state with the |000> state.

TABLE III
Comparison of the bias from no EM, PEC, EMRE, and HEMRE
under different depolarizing noise probabilities

| Noise | EM (samples) | | | |
|---|---|---|---|---|
| probability | No EM | PEC(1000) | EMRE(1000) | HEMRE(1000) |
| 0.01 | 0.3633 | 0.3636 | 0.4816 | 0.1134 |
| 0.005 | 0.248 | 0.2257 | 0.184 | 0.0974 |
| 0.001 | 0.0869 | 0.0645 | 0.0352 | 0.0460 |
| 0.0005 | 0.05273 | 0.0253 | 0.01309 | 0.024 |

It was found that the bias associated with the error mitigation by restricted evolution (EMRE) method is comparable (e.g., especially for low noise probabilities) to the bias from using probabilistic error cancellation (PEC) in many situations, and as shown in Table III, the EMRE method achieves better bias with a much smaller sample size as the noise probability decreases. Also, the bias associated with the hybrid error mitigation by restricted evolution (HEMRE) method is comparable or better than the bias from using probabilistic error cancellation (PEC) in many situations while providing a shorter runtime.

Thus, the hybrid error mitigation by restricted evolution (HEMRE) method of the embodiment provides considerable advantages, such as reduced sampling overhead while maintaining an acceptable amount of bias. Further, the runtime can be adjusted based on a set tolerable amount of bias.

According to an embodiment, the quantum computing device can use the generated average value to perform an action based on the estimated expectation value, e.g., calculating a ground state of a quantum system, which can used for a wide range of applications, such as quantum chemistry, material science, physics, cryptography etc. For instance, calculating the ground state for molecules can provide insights into their electronic structures, bond energies, and reaction mechanisms, can be used for drug discovery, and developing new materials.

According to one or more embodiments of the present disclosure, the quantum computing device can solve one or more technological problems in the existing technology, such as mitigating error in a quantum computer while reliably determining an expectation value of a physical observable and reduced sampling overhead while maintaining an acceptable amount of bias.

In addition, the quantum computing device can reliably determine an expectation value with hybrid error mitigation by restricted evolution that has a reduced runtime and reduced overhead sampling compared to PEC, which can be used for various applications, such as factoring, solving linear systems, quantum simulations, decryption, cryptography and quantum chemistry/material discovery.

According to one or more embodiments, the quantum computing device can adequately mitigate error using an elegant solution that drastically reduces processing times and conserves computing resources while still producing reliable results.

According to one or more embodiments, the quantum computing device can adequately mitigate error while providing an adjustable runtime according to bias tolerance.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for mitigating error in a quantum computing device, the method comprising:
receiving a quantum circuit configuration including a plurality of quantum gates;
generating an updated quantum circuit configuration by replacing a first gate among the plurality of quantum gates with at least one implemental quantum gate selected from among a set of implementable quantum gates based on a generalized quasi-probabilistic decomposition including a positive component and replacing a second gate among the plurality of quantum gates with at least two implemental quantum gates selected from among the set of implementable quantum gates based on a full quasi-probabilistic decomposition including a positive component and a negative component; and
executing the updated quantum circuit configuration, by the quantum computing device, to generate an expectation value.

2. The method of claim 1, further comprising:
repeatedly executing, by the quantum computing device, the updated quantum circuit configuration for a predetermined number of runs to generate a plurality of expectations values;
storing the plurality of expectations values corresponding to the predetermined number of runs in a memory of the quantum computing device; and
outputting an average expectation value corresponding to an average of the plurality of expectations values.

3. The method of claim 1, further comprising:
receiving a maximum tolerable bias for the expectation value;
determining a first group of gates within the quantum circuit configuration to be approximated based on corresponding generalized quasi-probabilistic decompositions based on the maximum tolerable bias; and
determining a second group of gates within the quantum circuit configuration to be represented based on corresponding full quasi-probabilistic decompositions.

4. The method of claim 3, further comprising:
obtaining an index including the plurality of quantum gates sorted from a smallest generalized robustness to a greatest generalized robustness;
selecting a selected gate from the index and comparing the selected gate to a first condition; and
in response to the first condition being satisfied, adding the selected gate to the first group of gates to be approximated.

5. The method of claim 4, wherein the first condition is defined by Equation:
$${s}_{incl} * {( gr [ G ] )}^{fr [ G ]} \leq {Δ}_{fixed} - ϵ + 1 ,$$
wherein s_{incl} is a product of robustness corresponding to the first group before the selected gate is added to the first group, gr[G] is a generalized robustness of the selected gate, fr[G] is a number of instances of the selected gate within the quantum circuit configuration, Δ_{fixed} is the maximum tolerable bias, and ϵ is a predetermined value corresponding to a precision of a sampling operation used while executing the updated quantum circuit configuration.

6. The method of claim 4, further comprising:
repeatedly iterating through the index and adding gates from among the plurality of gates to the first group until the first condition is violated; and
in response to the first condition being violated, adding one or more remaining gates among the plurality of gates to the second group.

7. The method of claim 3, further comprising:
obtaining an index including the plurality of quantum gates sorted from a greatest generalized robustness to a smallest generalized robustness;
determining a first range of gates within the index to be approximated based on a first condition associated with a first generalized robustness of the first range of gates;
determining a first sampling overhead associated with generating the expectation value based on approximating gates included in the first range of gates;
determining a second range of gates within the index to be approximated based on a second condition associated with a second generalized robustness of the second range of gates;
determining a second sampling overhead associated with generating the expectation value based on approximating gates included in the second range of gates;
comparing the second sampling overhead with the first sampling overhead; and
in response to the second sampling overhead being less than first sampling overhead, proceed to determining a third range of gates within the index to be approximated or outputting the second range of gates as the first group of gates within the quantum circuit configuration to be approximated.

8. The method of claim 1, wherein the full quasi-probabilistic decomposition is based on equation U=sB−(s−1)N, where U corresponds to a quantum gate in the quantum circuit configuration, B is a probabilistic combination of implementable quantum gates, N is a quantum channel, and s is a coefficient corresponding to a generalized robustness,
wherein sB corresponds to a positive component and −(s−1)N corresponds to a negative component, and
wherein the generalized quasi-probabilistic decomposition is based on sB and is not based on −(s−1)N.

9. The method of claim 8, wherein B is a probabilistic sum of at least two implementable operations including pₐA+p_{b}B, where A is a first implementable gate, B is a second implementable gate, pₐ is a first probability, and p_{b} is a second probability.

10. A method for mitigating error in a quantum computing device, the method comprising:
receiving a quantum circuit configuration including a plurality of quantum gates;
receiving a maximum tolerable bias for a result;
selecting at least one gate among plurality of quantum gates to be approximated based on the maximum tolerable bias;
generating an updated quantum circuit configuration by replacing the at least one gate with an approximation based on a generalized quasi-probabilistic decomposition including a positive component and at least one remaining gate among the plurality of quantum gates other than the at least one gate being represented based on a full quasi-probabilistic decomposition including a positive component and a negative component; and
executing the updated quantum circuit configuration, by the quantum computing device, to generate the result having a bias less than or equal to the maximum tolerable bias.

11. The method of claim 10, further comprising:
obtaining a list of the of the plurality of quantum gates sorted based on robustness;
iterating through the list, comparing gates from the list to a condition, and adding gates from the list to a first group of gates to be approximated based on the condition; and
replacing the gates in the first group with implementable operations based on generalized quasi-probabilistic decompositions for executing the updated quantum circuit configuration.

12. A quantum computing device, comprising:
a memory configured to store measured expectation values; and
a controller configured to:
receive a quantum circuit configuration including a plurality of quantum gates,
generate an updated quantum circuit configuration by replacing a first gate among the plurality of quantum gates with at least one implemental quantum gate selected from among a set of implementable quantum gates based on a generalized quasi-probabilistic decomposition including a positive component and replacing a second gate among the plurality of quantum gates with at least two implemental quantum gates selected from among the set of implementable quantum gates based on a full quasi-probabilistic decomposition including a positive component and a negative component, and
execute the updated quantum circuit configuration to generate an expectation value.

13. The quantum computing device of claim 12, wherein the controller is further configured to:
repeatedly execute the updated quantum circuit configuration for a predetermined number of runs to generate a plurality of expectations values,
store the plurality of expectations values corresponding to the predetermined number of runs in a memory of the quantum computing device, and
output an average expectation value corresponding to an average of the plurality of expectations values.

14. The quantum computing device of claim 12, wherein the controller is further configured to:
receive a maximum tolerable bias for the expectation value,
determine a first group of gates within the quantum circuit configuration to be approximated according to corresponding generalized quasi-probabilistic decompositions based on the maximum tolerable bias, and
determine a second group of gates within the quantum circuit configuration to be represented based on corresponding full quasi-probabilistic decompositions.

15. The quantum computing device of claim 14, wherein the controller is further configured to:
obtain an index including the plurality of quantum gates sorted from a smallest generalized robustness to a greatest generalized robustness,
select a selected gate from the index and comparing the selected gate to a first condition, and
in response to the first condition being satisfied, add the selected gate to the first group of gates to be approximated.

16. The quantum computing device of claim 15, wherein the first condition is defined by Equation:
$${s}_{incl} * {( gr [ G ] )}^{fr [ G ]} \leq {Δ}_{fixed} - ϵ + 1 ,$$
wherein s_{incl} is a product of robustness corresponding to the first group before the selected gate is added to the first group, gr[G] is a generalized robustness of the selected gate, fr[G] is a number of instances of the selected gate within the quantum circuit configuration, Δ_{fixed} is the maximum tolerable bias, and ϵ is a predetermined value corresponding to a precision of a sampling operation used while executing the updated quantum circuit configuration.

17. The quantum computing device of claim 15, wherein the controller is further configured to:
repeatedly iterate through the index and add gates from among the plurality of gates to the first group until the first condition is violated, and
in response to the first condition being violated, add one or more remaining gates among the plurality of gates to the second group.

18. The quantum computing device of claim 14, wherein the controller is further configured to:
obtain an index including the plurality of quantum gates sorted from a greatest generalized robustness to a smallest generalized robustness,
determine a first range of gates within the index to be approximated based on a first condition associated with a first generalized robustness of the first range of gates,
determine a first sampling overhead associated with generating the expectation value based on approximating gates included in the first range of gates,
determine a second range of gates within the index to be approximated based on a second condition associated with a second generalized robustness of the second range of gates,
determine a second sampling overhead associated with generating the expectation value based on approximating gates included in the second range of gates,
compare the second sampling overhead with the first sampling overhead, and
in response to the second sampling overhead being less than first sampling overhead, determine a third range of gates within the index to be approximated or output the second range of gates as the first group of gates within the quantum circuit configuration to be approximated.

19. The quantum computing device of claim 12, wherein the full quasi-probabilistic decomposition is based on equation U=sB−(s−1)N, where U corresponds to a quantum gate in the quantum circuit configuration, B is a probabilistic combination of implementable quantum gates, N is a quantum channel, and s is a coefficient corresponding to a generalized robustness,
wherein sB corresponds to a positive component and −(s−1)N corresponds to a negative component, and
wherein the generalized quasi-probabilistic decomposition is based on sB and is not based on −(s−1)N.

20. The quantum computing device of claim 19, wherein B is a probabilistic sum of at least two implementable operations including pₐA+p_{b}B, where A is a first implementable gate, B is a second implementable gate, pₐ is a first probability, and p_{b} is a second probability.
